(19) United States
(12) Patent Application Publication
(10) Pub. No.: US 2014/0138506 A1
(43) Pub. Date: May 22, 2014

(54) Support System with Lock

(71) Applicant: Ergotron, Inc., Eagan, MN (US)

(72) Inventors: Ryan Dahl, Inver Grove Heights, MN (US); Scott Trish, Lakeville, MN (US); Saeb Asamarai, Columbia Heights, MN (US)

(73) Assignee: Ergotron, Inc., Eagan, MN (US)

(21) Appl. No.: 14/079,937

(22) Filed: Nov. 14, 2013

Related U.S. Application Data
(60) Provisional application No. 61/727,463, filed on Nov. 16, 2012.

(51) Int. Cl. F16M 13/02; F16C 11/10

(52) U.S. Cl. CPC F16M 13/022; F16C 11/103
USPC 248/276.1; 248/309.1; 248/295.11; 248/299.1; 403/110; 29/464

(57) ABSTRACT

A support system with a locking mechanism for positioning and securing electronic equipment. The support system includes a base, a riser coupled to the base, a support coupled to the riser and a locking mechanism positioned at a distal end of the riser. The locking mechanism includes a first block, a second block and a fastener. The first block has a first aperture, a first inclined surface and distal surface including a lip. The second block comprising a second aperture and a second inclined surface, wherein tightening the fastener slides the first block with respect to the second block, such that the first inclined surface wedges against the second inclined surface. Methods of locking a support to a riser using the locking mechanism.

### RELATED APPLICATIONS

This application claims priority to U.S. Provisional Application Ser. No. 61/727,463, filed Nov. 16, 2012, the contents of which are hereby incorporated by reference.

### FIELD

This disclosure generally relates to systems and methods for securing electronic equipment to a support system.

### BACKGROUND

A support system can be used for mounting and/or adjusting the position of electronic equipment such as monitors.

### SUMMARY

Embodiments of the invention include a locking mechanism for securing electronic equipment to a support system. The locking mechanism can include a first block, a second block, and a fastener. The first block can include a first aperture, a first inclined surface, and a distal surface opposite the first inclined surface. The distal surface can include a lip. The second block can include a second aperture in axial alignment with the first aperture and a second inclined surface in apposition to the first inclined surface. The first aperture can extend through a distal surface opposite the first inclined surface and the first inclined surface. The second aperture can extend through the second inclined surface. The fastener can extend through the first and second apertures. The first inclined surface of the first block can be adapted to slide with respect to the second inclined surface when the fastener is tightened to increase a force between the first and second inclined surfaces. The first and second blocks can be configured to move when the fastener is tightened, such that a portion of the first inclined surface extends laterally beyond the second block, a portion of the second inclined surface extends laterally beyond the first block, or a portion of the first inclined surface extends laterally beyond the second block and a portion of the second inclined surface extends laterally beyond the first block. In such embodiments, the first inclined surface of the first block can wedge against the second inclined surface of the second block when the fastener is tightened.

Embodiments of the invention can also include a support system for electronic equipment with a locking mechanism as described elsewhere herein. The support system can include a base, a riser extending from the base, a support coupled to the riser, and a locking mechanism. The riser can define a cavity bound by an interior surface. The locking mechanism can be received within the cavity of the riser.

An embodiment of a method of locking a support coupled to electronic equipment to a riser can include one or more of the following steps: (i) providing a locking mechanism such as those described elsewhere herein, (ii) aligning the second block with respect to the first block such that the second aperture is axially in-line with the first aperture, and the second inclined surface is in apposition to the first inclined surface, and (iii) tightening the fastener so that the first block slides with respect to the second inclined surface to increase a force between the first and second inclined surfaces.

### BRIEF DESCRIPTION OF DRAWINGS

The following drawings are illustrative of particular embodiments of the present invention and therefore do not limit the scope of the invention. The drawings are not necessarily to scale (unless so stated) and are intended for use in conjunction with the explanations in the following detailed description. Embodiments of the invention will hereinafter be described in conjunction with the appended drawings, wherein like numerals denote like elements.

FIG. 1 is a perspective view of a support system including a locking mechanism in accordance with an embodiment of the invention;

FIG. 2 is a perspective view of a support system including the locking mechanism and a second embodiment of a support in accordance with a second embodiment of the invention;

FIG. 3 is a side view of the support system of FIG. 2;

FIG. 4 is a close-up view of distal portion A of FIG. 3 illustrating a side view of the locking mechanism in accordance with an embodiment of the invention;

FIG. 5 is an exploded perspective view of the locking mechanism of FIG. 4;

FIG. 6 is an exploded side view of an embodiment of first and second blocks of the locking mechanism of FIG. 5;

FIG. 7A is a perspective view of the first block of the locking mechanism of FIG. 5;

FIG. 7B is a top view of the first block of FIG. 7A;

FIG. 7C is a side view of the first block of FIG. 7A;

FIG. 7D is a bottom view of the first block of FIG. 7A;

FIG. 8A is a perspective view of the second block of the locking mechanism of FIG. 5;

FIG. 8B is a top view of the second block of FIG. 8A;

FIG. 8C is a side view of the second block of FIG. 8A;

FIG. 8D is a bottom view of the second block of FIG. 8A;

FIG. 9A is a side view of the locking mechanism of FIG. 5 in an assembled and unlocked state; and

FIG. 9B is a side view of the locking mechanism of FIG. 9A in a locked state.

### DETAILED DESCRIPTION OF THE PREFERRED EMBODIMENTS

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

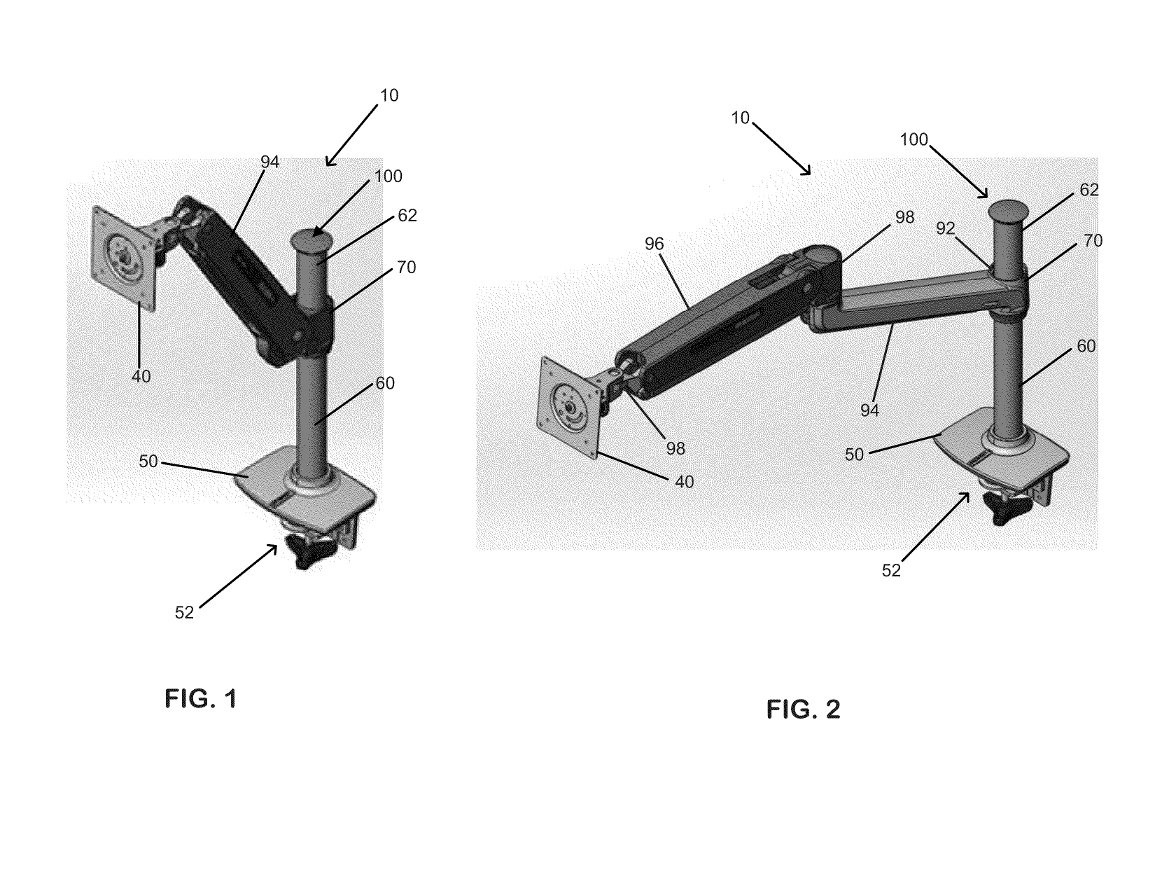

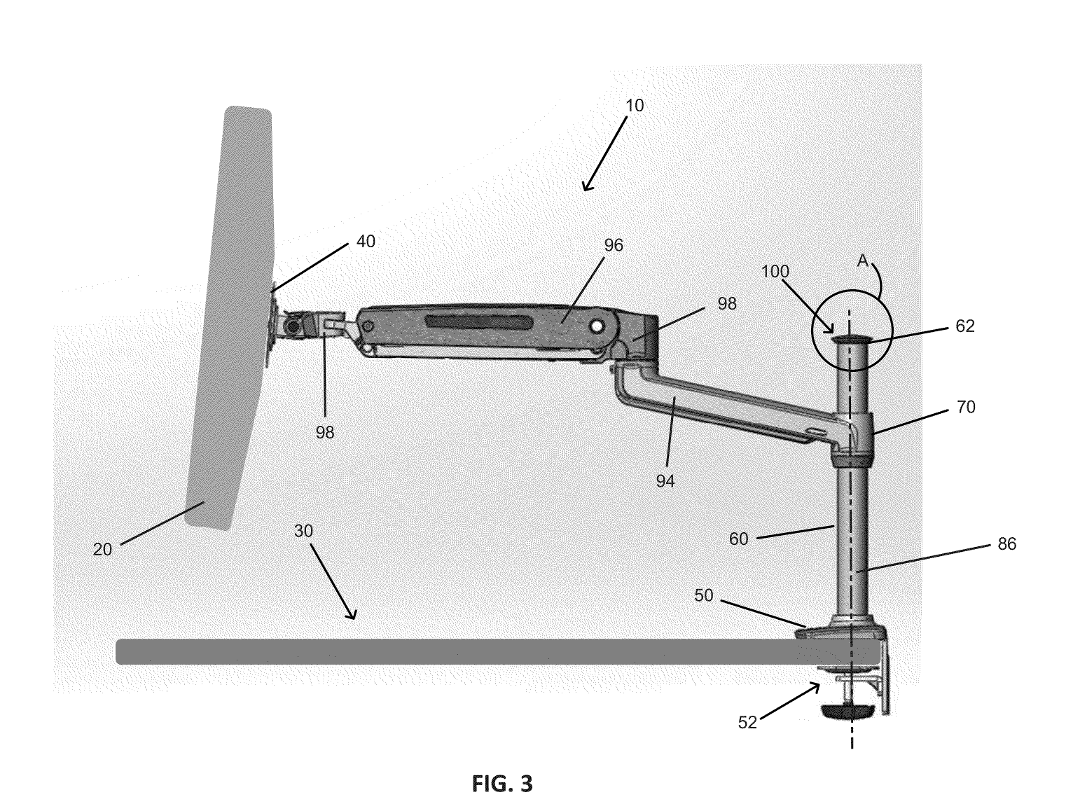

Embodiments described herein can be useful for lockably mounting and positioning electronic equipment on a support system. FIGS. 1 and 2 are perspective views of embodiments of a support system 10 for electronic equipment (e.g., a monitor) and FIG. 3 is a front view of the support system shown in FIG. 2 holding electronic equipment 20. As shown, in some embodiments the support system 10 can be configured for mounting the electronic equipment 20 to a support surface 30 (e.g., a desk). The support system 10 can include a mounting bracket 40 (e.g., a VESA bracket) adapted to receive the electronic equipment 20. In some embodiments, the support system 10 can include a base 50, a riser 60, a support 70 and a locking mechanism 100.

The support system can assume any configuration useful for positioning electronic equipment. In some embodiments, the base 50 can include a clamp 52 adapted to attach the support system 10 to an edge of a support surface 30. In other embodiments, the base 50 may include a grommet mount adapted to engage with a grommet hole on a support surface. Such embodiments can be useful for securing electronic equipment coupled to the support system to a rigid work surface.

Referring to FIGS. 1 and 2, the support 70 can be operatively coupled to the riser 60. In some embodiments, the support 70 can slidingly engage with the riser 60, and can be rotatably engaged about the riser 60. The support 70 defines an aperture 92 sized to receive the riser 60. In some embodiments, the support 70 includes one or more arms, such as a first arm 94. The first arm 94 can be adapted to engage with the mounting bracket 40 or additional arms and support the electronic equipment 20. As shown in FIGS. 2 and 3, the support 70 can include a second arm 96 with joints 98 articulating with respect to the riser 60. The joints 98 are adapted to move and reposition electronic equipment 20 supported by the second arm 96.

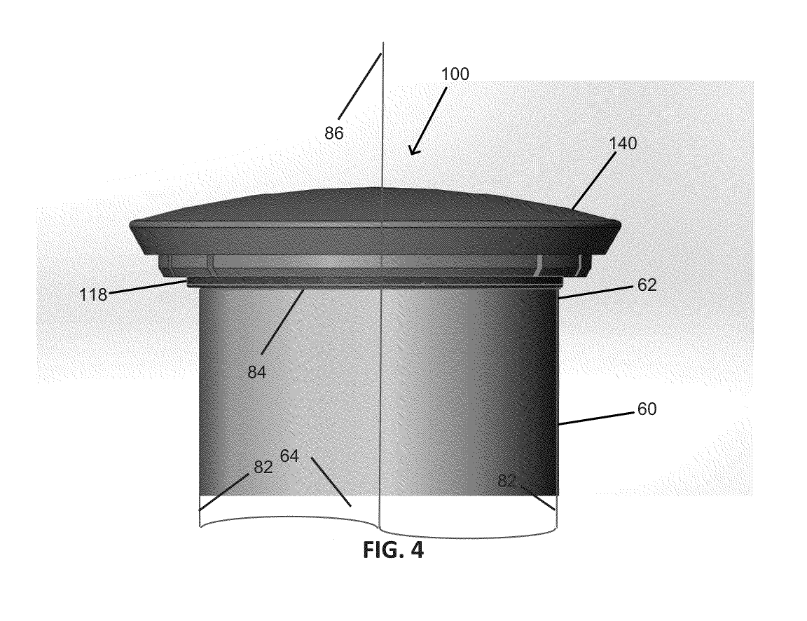

As shown in FIGS. 3 and 4, the riser 60 can extend vertically from the base 50 and include a cavity 64 defined by an interior surface 82 of the riser 60 (e.g., the riser 60 can be a hollow cylinder). A leading edge 84 of the riser 60 can be generally perpendicular to a longitudinal axis 86 of the riser 60. For purposes of illustration, hidden elements have been schematically projected over the side views of FIGS. 3 and 4. The leading edge 84 can define a perimeter of the interior surface 82 forming the cavity 64 of the riser 60. In the illustrated embodiments, the riser 60 is cylindrical in shape, leading to the leading edge defining the circumference of the cylindrical riser 60.

With continued reference to FIGS. 3 and 4, the locking mechanism 100 can restrict the removal of the support 70 from the riser 60. In some embodiments, the locking mechanism 100 can be positioned at the distal end 62 of the riser 60. In certain embodiments, the locking mechanism 100 can be received by the cavity 64 in the riser 60.

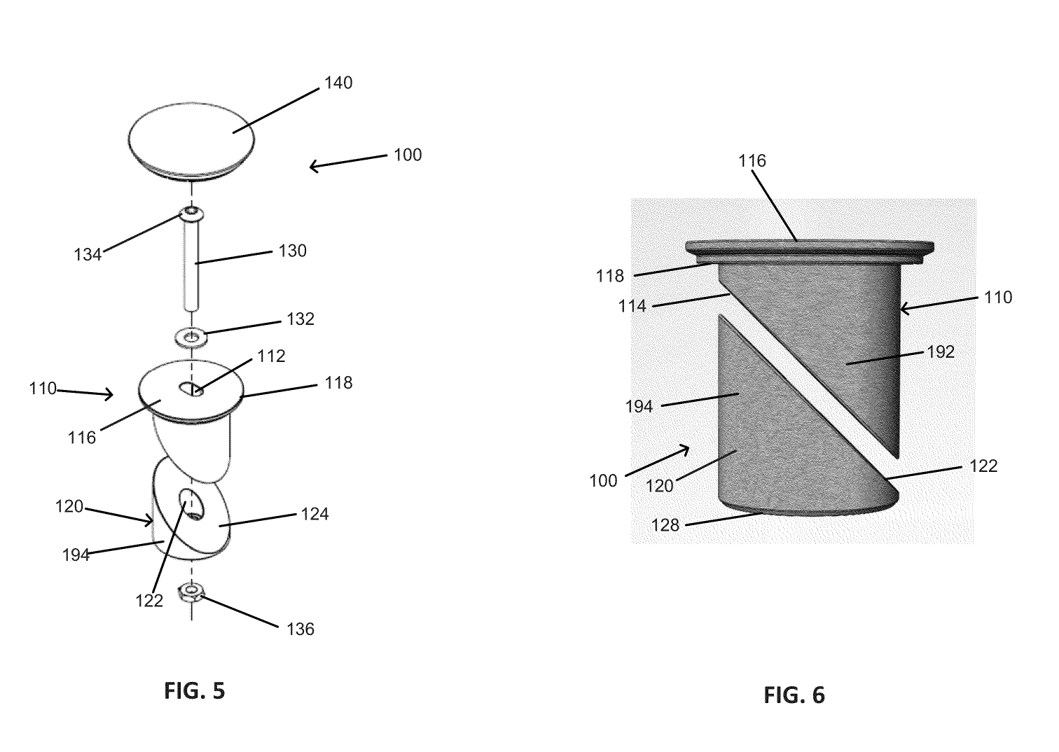

FIGS. 5 and 6 illustrate respectively, an exploded perspective view and an exploded side view of the locking mechanism 100 according to some embodiments. The locking mechanism 100 can include a first block 110, a second block 120 and a fastener 130. The first block 110 can include a first aperture 112, a first inclined surface 114, and a distal surface 116 opposite the first inclined surface 114. The distal surface 116 can include a lip 118. The second block 120 can include a second aperture 122 in axial alignment with the first aperture 112 and a second inclined surface 124 in apposition to the first inclined surface 114.

In some embodiments, the first aperture 112 can extend through the distal surface 116 and the first inclined surface 114. The second aperture 122 can extend through the second inclined surface 124. The fastener 130 can extend through the first and second apertures 112,122. The fastener can include a washer 132 seated on the distal surface 116 of the first block 110. In some embodiments, a cap 140 coupled to the distal surface or the riser can be provided to cover the first block 110. In such embodiments, the cap 140 can also cover a head 134 of the fastener 130 seated in the first aperture 112 of the first block 110.

As best seen in FIG. 6, the first block 110 includes a distal surface 116 opposite the first inclined surface 114. The distal surface 116 includes a lip 118 adapted to prevent the support from disengaging with the riser 60. Referring back to FIG. 4, the lip 118 can extend beyond a perimeter of the riser 60. The lip 118 can be in apposition to the leading edge 84 of the riser 60. In some embodiments, the lip 118 of the locking mechanism 100 can be larger than the aperture defined by the support.

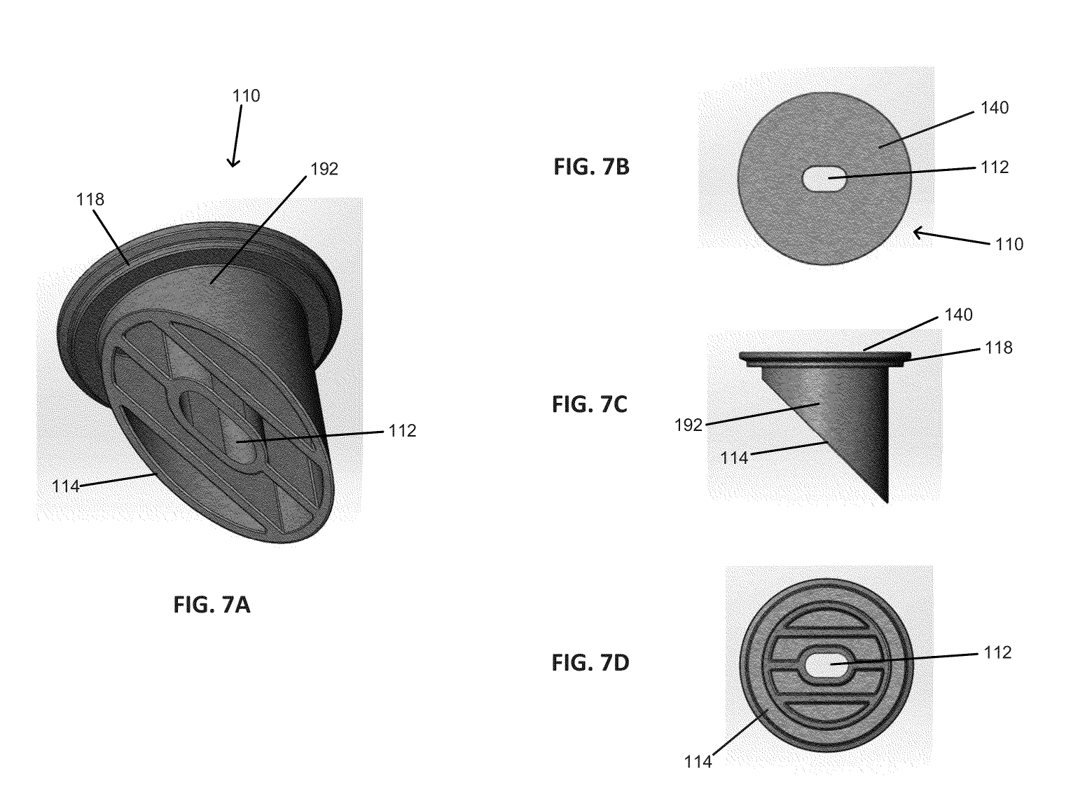

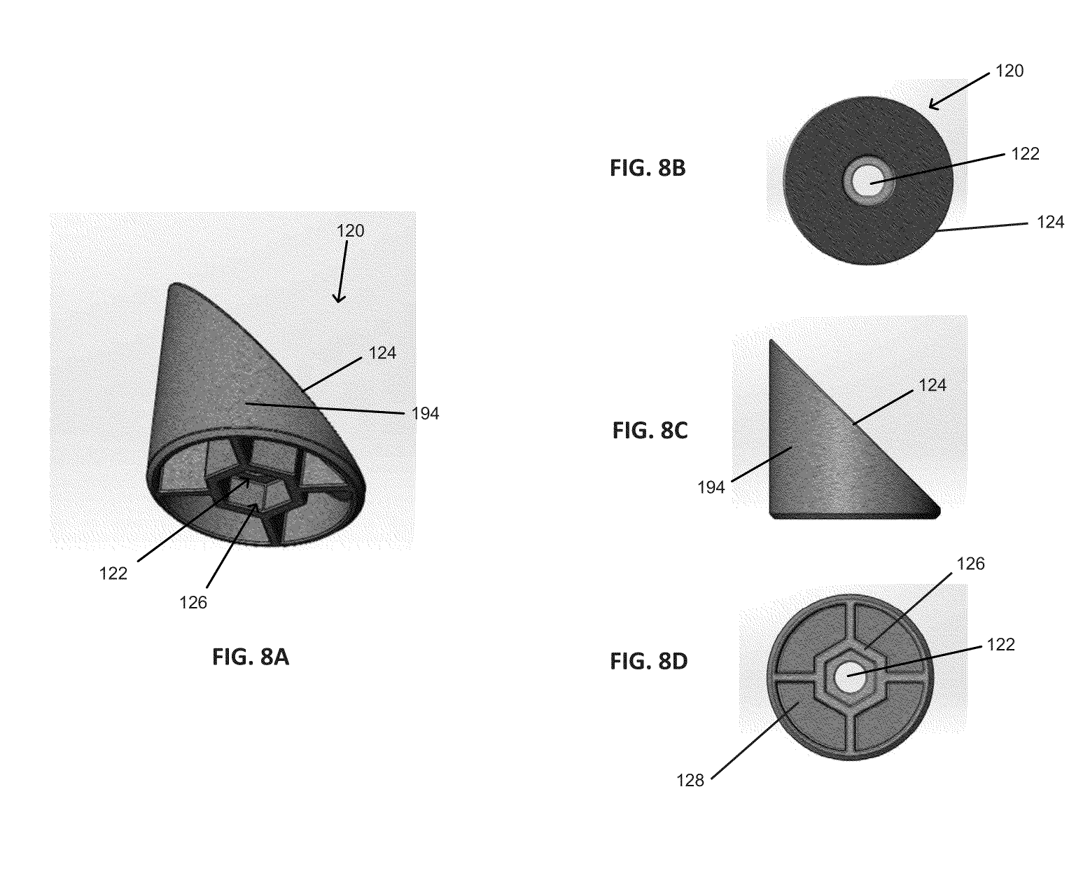

FIGS. 7A-7 D and 8A-8 D illustrate various views of the first block 110 and the second block 120, respectively. From FIGS. 7A and 8A, it can be seen that certain embodiments of the first block 110 and the second block 120 have the shape of a truncated cylinder (e.g., a cylindrical wedge). As shown, a plane of truncation can be non-parallel with a longitudinal axis of the cylinder. The shape of the first block 110 and the second block 120 are such that the first block 110 and second block 120 can wedge against each other if either of the first and second blocks 110, 120 moves relative to each other. As seen in FIGS. 7B and 8B, the first block 110 and the second block 120 can each have a circular profile when viewed from a top. As seen in FIGS. 7C and 8C, the first block 110 and the second block 120 each have a triangular profile when viewed from a side.

The fastener 130 includes a threaded portion (not shown) adapted to threadingly engage with a locking nut 136. The fastener 130 can include a bolt, nut and washer assembly. As best seen in FIGS. 8A and 8D, the second block 120 can include a recess 126 adapted to receive the locking nut 136. The recess 126 can be positioned at a proximal surface 128 of the second block 120. The first aperture 112 can include an elongate portion, such as a rounded rectangular shape (e.g., a rounded slot) such that the first block 110 can move laterally relative to the fastener 130 as it is tightened. The second aperture 122 can have a circular shape.

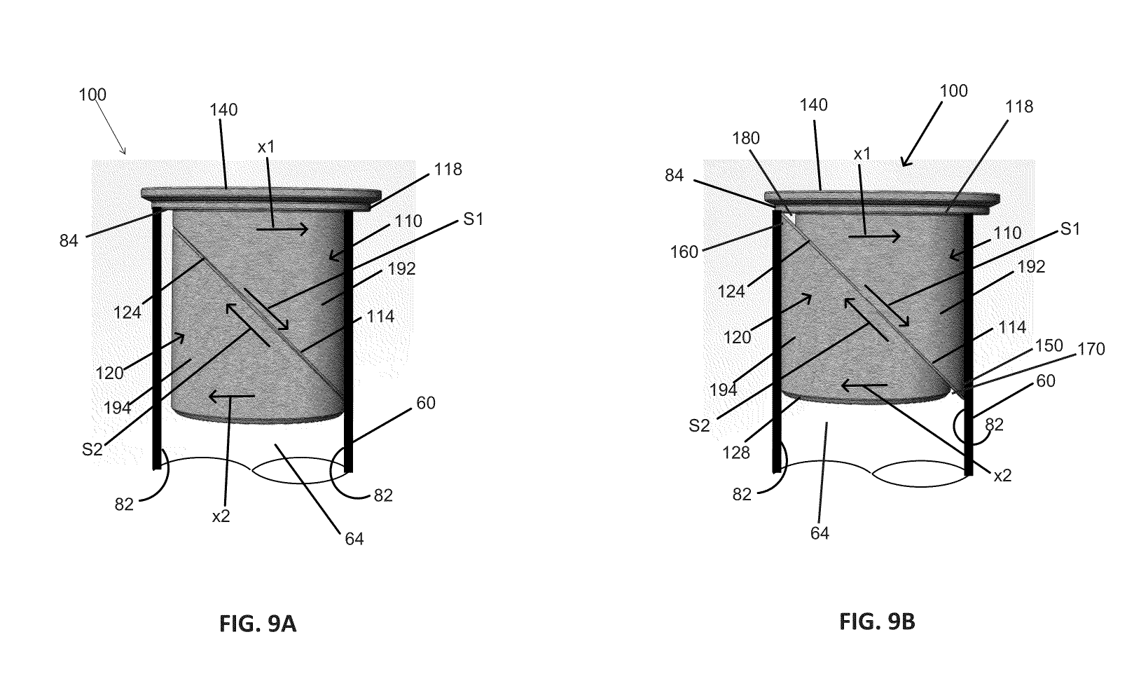

In a non-limiting exemplary embodiment, the fastener 130 can be a bolt with right-handed threads. In such embodiments, a clockwise rotation can move the fastener 130 in a substantially downward direction and apply a force on the first and second blocks 110, 120. The force imparted by tightening the fastener 130 can cause the first and second inclined surfaces 114, 124 to wedge against each other, and consequently moving the first block 110 and second block 120 in opposing directions. The directions of movement of the first block 110 and the second block 120 “x1” and “x2” are illustrated in FIGS. 9A and 9B. Tightening the fastener 130 moves the first block 110 in a first direction “x1”, and the second block 120 in a second direction “x2”. The second direction “x2” can be opposite the first direction “x1”. The fastener 130 can be fixedly coupled to the second block 120 by the locking nut 136 positioned in the recess 126 (best seen in FIG. 8D), such that when the second block 120 moves in a second direction “x2”, the fastener 130 moves by a first distance along the second direction “x2”.

Referring back to FIGS. 9A and 9B, the first inclined surface 114 of the first block 110 can be adapted to slide with respect to the second inclined surface 124 when the fastener 130 is tightened to increase a force between the first and second inclined surfaces 114, 124. The first inclined surface 114 slides in a direction “s1” opposing the direction of sliding “s2” of the second inclined surface 124. The first and second blocks 110, 120 can be configured to move when the fastener 130 is tightened, such that a portion 150 of the first inclined surface 114 extends laterally beyond the second block 120 and/or a portion 160 of the second inclined surface 124 extends laterally beyond the first block 110. In some embodiments, the portions that extend laterally beyond the first block 110 and second block 120 can each define a gap. In the illustrated embodiment, the truncated cylindrical shapes of the first and second blocks 110, 120 lead to gaps 170, 180 that are shaped as truncated cylinders. As shown, when viewed from a side, the gaps 170, 180 are triangular in shape.

With continued reference to FIGS. 9A and 9B, turning or tightening the fastener 130 imparts a force to the first and second blocks 110, 120. The movements of the first and second blocks 110, 120 can continue until outer surfaces 192 and 194 of the first and second blocks 110, 120 abut and are positioned snugly against the interior surface 82 the of riser 60. Once positioned against the interior surface 82 of the riser 60, the lip 118 of the distal surface 116 will be in apposition to the leading edge 86 of the riser and extend beyond the perimeter 84 of the riser 60. The lip 118 can prevent the removal of the support and the electronic equipment 20 coupled to the support from the riser after the locking mechanism 100 is secured against the interior surface 82 of the riser 60.

Embodiments described elsewhere herein can be useful for supporting and locking electronic equipment to a support surface (e.g., desk). A method of locking a support to a riser can include one or more of the following steps: (i) providing a locking mechanism such as those described elsewhere herein, (ii) aligning the second block with respect to the first block such that the second aperture is axially in-line with the first aperture, and the second inclined surface is in apposition to the first inclined surface, and (iii) tightening the fastener so that the first block slides with respect to the second inclined surface to increase a force between the first and second inclined surfaces, wherein a portion of the first inclined surface extends laterally beyond the second block and a portion of the second inclined surface extends laterally beyond the first block.

Thus, embodiments of the invention are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention.

What is claimed is:

1. A locking mechanism for securing electronic equipment to a support system, the locking mechanism comprising:
a first block comprising a first aperture, a first inclined surface, and a distal surface opposite the first inclined surface, the distal surface including a lip, the first aperture extending through the distal surface and the first inclined surface;
a second block comprising a second aperture in axial alignment with the first aperture, a second inclined surface in apposition to the first inclined surface, the second aperture extending
through the second inclined surface; and
a fastener extending through the first and second apertures, wherein,
the first inclined surface of the first block is adapted to slide with respect to the second inclined surface when the fastener is tightened to increase a force between the first and second inclined surfaces such that a portion of the first inclined surface extends laterally beyond the second block, a portion of the second inclined surface extends laterally beyond the first block, or both the portion of the first inclined surface extends laterally beyond the second block and the portion of the second inclined surface extends laterally beyond the first block.

2. A support system for electronic equipment, comprising:
a base;
a riser defining a cavity bound by an interior surface extending from the base;
a support coupled to the riser; and
a locking mechanism received within the cavity of the riser, the locking mechanism including
a first block comprising a first aperture, a first inclined surface, and a distal surface opposite the first inclined surface, the distal surface including a lip, the first aperture extending through the distal surface and the first inclined surface,
a second block comprising a second aperture in axial alignment with the first aperture, a second inclined surface in apposition to the first inclined surface, the second aperture extending through the second inclined surface, and
a fastener extending through the first and second apertures, wherein,
the first inclined surface of the first block is adapted to slide with respect to the second inclined surface when the fastener is tightened to increase a force between the first and second inclined surfaces such that a portion of the first inclined surface extends laterally beyond the second block, a portion of the second inclined surface extends laterally beyond the first block, or both the portion of the first inclined surface extends laterally beyond the second block and the portion of the second inclined surface extends laterally beyond the first block., and
the first inclined surface of the first block wedges against the second inclined surface of the second block when the fastener is tightened.

3. The support system of claim 2, further comprising a cap coupled to the distal surface or a distal end of the riser, the cap adapted to cover the first block of the locking mechanism.

4. The support system of claim 3, wherein the locking mechanism is positioned near the distal end of the riser.

5. The support system of claim 2, wherein tightening the fastener moves the first block in a first direction, and the second block in a second direction, the second direction being opposite to the first direction.

6. The support system of claim 2, wherein the lip is adapted to prevent the support from disengaging with the riser.

7. The support system of claim 2, wherein the lip extends beyond a perimeter of the riser and is in apposition to a leading edge of the riser, the leading edge generally perpendicular to a longitudinal axis of the riser.

8. The support system of claim 2, wherein the fastener includes a threaded portion adapted to threadingly engage with a locking nut.

9. The support system of claim 8, wherein the second block includes a recess adapted to receive the locking nut.

10. The support system of claim 8, wherein movement of the second block in a second direction results in movement of the fastener by a first distance along the second direction.

11. The support system of claim 2, wherein the first aperture includes an elongate portion such that the first block can move laterally relative to the fastener as it is tightened.

12. The support system of claim 2, wherein the support includes a first arm, the first arm operably coupled to a bracket adapted to receive the electronic equipment.

13. The support system of claim 12, wherein the support includes a second arm with joints articulating with respect to the riser, the second arm coupled to the first arm and adapted to receive the electronic equipment, the joints adapted to move and reposition the electronic equipment.

14. The support system of claim 2, wherein the base comprises a clamp, the clamp adapted to attach the support system to a support surface.

15. The support system of claim 2, wherein the first block and the second block each have a circular profile when viewed from a top.

16. The support system of claim 2, wherein the first block and the second block each have a triangular profile when viewed from a side.

17. The support system of claim 2, wherein in a first position the locking mechanism has a rectangular profile when viewed from a side and in a second position, the first inclined surface of the first block and the second inclined surface of the second block define a first triangular gap and a second triangular gap, when viewed from a side.

18. The support system of claim 2, wherein the first and second blocks have a truncated cylindrical shape.

19. The support system of claim 2, wherein the support is slidingly engaged with the riser.

20. The support system of claim 2, wherein the support is rotatably engaged about the riser.

21. The support system of claim 2, wherein the support defines an aperture sized to receive the riser, the lip of the locking mechanism being larger than the aperture defined by the support.

22. The support system of claim 2, wherein the support includes a first arm.

23. The support system of claim 2, wherein the support is adapted to receive a monitor.

24. A method of locking a support to a riser, comprising:
providing a locking mechanism at a distal end of the riser, the locking mechanism comprising:
a first block comprising a first aperture, a first inclined surface, and a distal surface opposite the first inclined surface, the distal surface including a lip, the first aperture extending through the lip and the first inclined surface,
a second block comprising a second aperture extending through a second inclined surface, and
a fastener extending through the first and second apertures;
aligning the second block with respect to the first block such that the second aperture is axially in-line with the first aperture, and the second inclined surface is in apposition to the first inclined surface; and
tightening the fastener to increase a force between the first and second inclined surfaces so that the first inclined surface slides with respect to the second inclined surface, wherein a portion of the first inclined surface extends laterally beyond the second block and a portion of the second inclined surface extends laterally beyond the first block.
